(19) United States
(12) Patent Application Publication
(10) Pub. No.: US 2011/0108213 A1
(43) Pub. Date: May 12, 2011

(54) Garage Door

(75) Inventor: Gregory B. James, Lake Munmorah (AU)

(73) Assignee: ADAPTABLE GARAGE DOORS PTY LTD, Parramatta (AU)

(21) Appl. No.: 12/086,815

(22) PCT Filed: Oct. 31, 2006
(86) PCT No.: PCT/AU2006/001627

§ 371 Date: Jan. 18, 2011

(30) Foreign Application Priority Data
Oct. 31, 2005 (AU) 2005906022

(51) Int. Cl. E06B 3/52; E05D 15/52; E05F 15/08; E05F 1/08; B23P 11/00

(52) U.S. Cl. 160/231.1; 160/229.1; 16/197; 29/428

(57) ABSTRACT

A counterbalance apparatus (60) for an overhead door (12) of the sectional type has a torsion spring assembly (62, 64, 66, 70) mounted so as to be raised and lowered with operation of the door curtain (14.1, 14.2, 14.3, 14.4). The torsion spring assembly (62, 64, 66, 70) is loaded as the door (12) is lowered. A drive motor (100) of a drive mechanism of the door (12) can be mounted on the door curtain (14.1).

### FIELD OF THE INVENTION

The present invention relates generally to overhead ‘garage’ doors, of the type used to close large openings in residential and commercial buildings. More particularly, the present invention relates to overhead doors of the sectional type, and to a counterbalance arrangement for such doors.

### BACKGROUND OF THE INVENTION

Sectional garage doors are well known in the art. Although the design of sectional garage doors can differ, certain components are common to such door systems. Thus a typical sectional garage door has a door curtain made of a plurality—usually four or more—panel sections hinged together at their longitudinal edges about horizontal hinge axes.

A pair of generally inverted L-shaped guide tracks is mounted to the building, one at each side of the door opening, with the vertical leg of the L being at the side of the door opening and the horizontal leg being above the level of the opening and extending back into the building space. The junction of the horizontal and vertical legs of the track is radiussed.

The door includes a plurality of rollers mounted on the opposite sides of the door sections, which follow the guide tracks to guide movement of the door curtain between a closed (lowered) position in which the door is vertical and closes off the door opening and an open (raised) position where the door is stored overhead in a horizontal orientation.

Since a sectional door is relatively large and heavy, it is commonplace to provide a counter-balancing spring system which loads up one or more torsion or extension springs as the door is lowered, so that the spring tension assists raising of the door. Such systems are commonly used even where the door is power operated.

A typical counter-balancing system includes one or more torsion springs on a horizontal torsion shaft which is secured to the building structure above the door opening. The shaft has a cable drum with a cable connected to the bottom section of the door. As the door is lowered, the withdrawal of the cable causes the shaft to turn, winding up the torsion spring. The number and size of the springs is selected so that spring tension is selected to counterbalance part of the weight of the door, so that the door is easier to raise.

A typical counter-balancing system of this type requires a headroom clearance in the range of 250-375 mm. This can be reduced a little by installation of a low-headroom kit, which diverts the cable horizontally by a pulley at the top of the door and the torsion bar is installed overhead some distance back from the door opening.

One of the main disadvantages of prior art overhead counter-balancing systems is that they place significant limitation on the height of door opening which can be achieved in low head room environments, i.e. where there is little overhead space between the top of the door opening and a ceiling or similar surface. Other disadvantages include difficulty of installation and unsightly appearance. Also, it is sometimes difficult to locate secure fixing points on the building structure for attachment of the counter-balancing system.

The present invention aims to provide a new and useful counterbalancing system suitable for use in low-headroom environments, and further new and useful improvements to overhead door systems as described herein.

Any reference herein to known prior art does not, unless the contrary indication appears, constitute an admission that such prior art is commonly known by those skilled in the art to which the invention relates, at the priority date of this application.

### SUMMARY OF THE INVENTION

In one general form, the invention resides in mounting a spring mechanism of the counterbalancing apparatus so as to be raised and lowered with operation of the door curtain, and providing a loading mechanism for loading the spring mechanism as the door is lowered.

In one preferred form, a drive motor of a drive mechanism of the door is also mounted on the door curtain.

In a further form, the invention resides in providing a forwardly extending recess in a guide track of the door system adjacent the top of the door, into which a guide of an uppermost panel section is received when the door is closed.

Further forms of the invention are as described in the attached claims.

### BRIEF DESCRIPTION OF THE DRAWINGS

An embodiment or embodiments of the present invention will now be described, by way of example only, with reference to the accompanying drawings, in which:

FIG. 1 is a schematic perspective view of a sectional door system according to the present invention utilizing a torsion spring assembly for counterbalancing a sectional door;

FIG. 2 is a schematic side view of a sleeve-rod arrangement of the sectional door system of FIG. 1;

FIG. 3 is a schematic front view of the sleeve-rod arrangement of FIG. 2;

FIG. 4 is a perspective view of the sleeve-rod arrangement of FIG. 2;

FIG. 5 is a perspective front view of a torsion spring assembly attached to a bottom door panel of the sectional door system of FIG. 1;

FIG. 6 is a schematic cross-sectional view of the bottom door panel of FIG. 5;

FIG. 7 is an enlarged view of the bottom door panel of FIG. 5 showing details of a muntin and cable drum arrangement of FIG. 5;

FIG. 8 is a partial perspective view of the door system of FIG. 1 showing mounting of a torsion cover to the bottom door panel of FIG. 5;

FIG. 9 is a schematic side view of a track and top guide roller arrangement known in the prior art;

FIG. 10 is a schematic side view of a track and top guide roller arrangement according to an embodiment of the invention;

FIG. 11 is a schematic rear elevation of a door-mounted motorised lift mechanism according to a further embodiment;

FIGS. 12 and 13 show a first embodiment of the drive arrangement of FIG. 11 in more detail; and

FIGS. 14 and 15 show respectively the power supply transformer arrangement and the finished bottom panel appearance of a second embodiment of the drive mechanism of FIG. 11.

FIGS. 16 and 17 show a door latch arrangement.

### DETAILED DESCRIPTION OF THE EMBODIMENT OR EMBODIMENTS

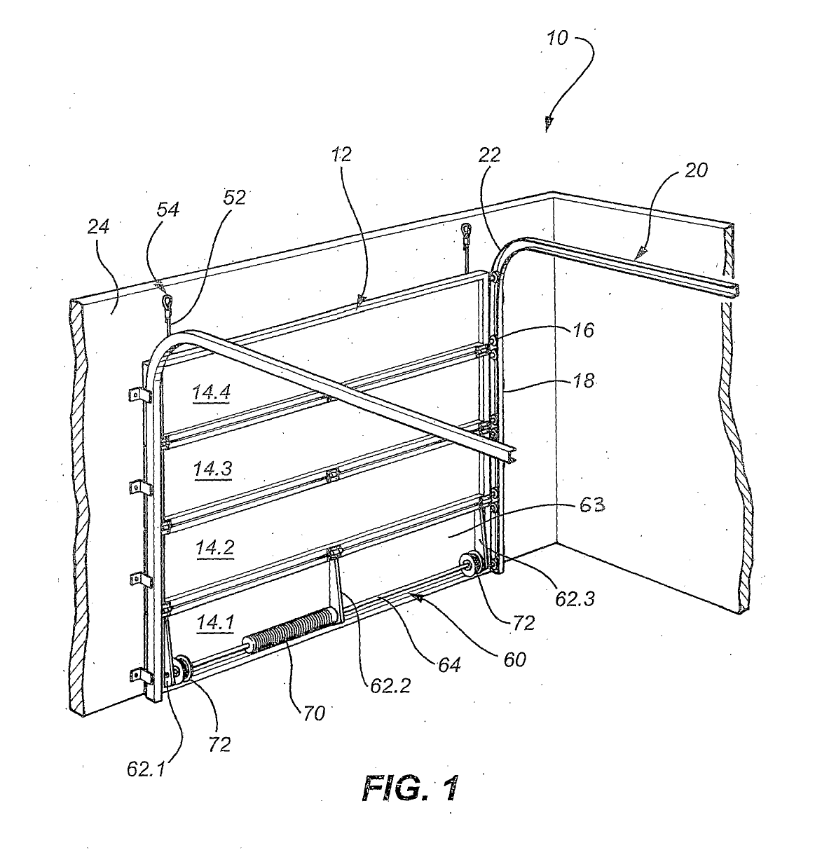

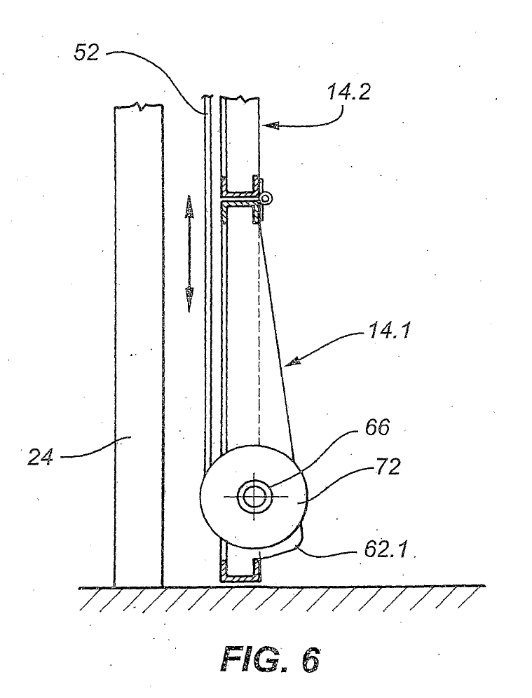

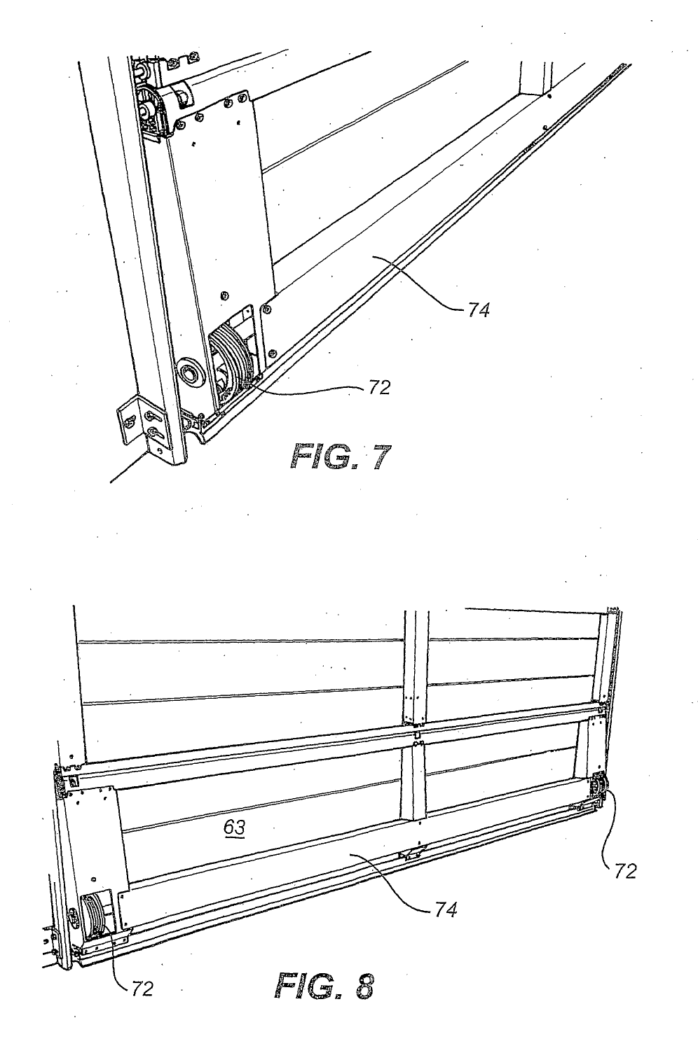

With reference to the FIGS. 1-8, 10 and to FIG. 1 in particular, a garage door system 10 is shown in accordance with the principles of the present invention. The system 10 includes a sectional garage door 12 having a plurality of sectional door panels 14.1, 14.2, 14.3, 14.4., each pivotally attached to at least one adjacent sectional door panel. Depending on the width of the door 12, the panels may further include vertical and/or horizontal reinforcing members (not shown).

The mounting of the door to the building structure is done in generally the same fashion as is done in the prior art.

The door 12 rides on guide rollers 16 which engage and travel within a pair of tracks 18 and 20 at each side of the door 12. These tracks include a vertical track section 18 which is connected to a horizontal track section 20 having an intermediate arcuate portion 22. It will be appreciated by those skilled in the art that the present invention embraces a “horizontal” track disposed at an angle to a horizontal line (eg, a track extending parallel to the slope of a roof etc).

Vertical track 18 is attached to a wall 24 of a garage (or to a side jamb) with brackets using conventional fasteners such as screws, bolts, etc (not shown) at the side of the door opening so that the track 18 is substantially parallel to door 12 when door 12 is in its closed position.

The horizontal track 20 is attached to a building ceiling or similar structure or a head jamb using brackets and conventional fasteners (not shown).

As shown in FIG. 1, and further illustrated in FIGS. 5-7, a torsion spring counterbalance assembly generally referred to as 60 is mounted to the bottom door panel 14.1.

The torsion spring assembly itself is of construction and operation similar to those used in the prior art, except instead of being mounted above the door it is mounted on the door panel 14.1. The general construction and operation of such torsion spring arrangements will be well understood to those skilled in the relevant art.

The torsion spring assembly is secured to the panel via modified bottom muntins (vertical reinforcing members) 62.1, 62.2, 62.3 of the panel frame 63. To this end, the muntins 62 are tapered outwardly towards their bottom to accommodate the counter-balancing assembly 60. The side muntins 62.1 and 62.3 thus perform the function of end bracket plates of a conventional overhead counter-balancing assembly, with the centre muntin 62.2 capable of performing the function of a centre plate.

The counterbalance assembly 60 includes a torsion shaft 64 rotatably journalled in bearings 66 provided in the muntins 62. The torsion shaft 64 spans between the muntins 62.1 and 62.3 and extends the entire width of the doorway. Alternatively, depending on the length of the door, the torsion shaft 64 may have one or more sections that are connected in a manner that will allow torque to be transmitted between each section.

Disposed on the torsion shaft 64 are one or more torsion springs 70 (only one torsion spring is shown). The inner end of the torsion spring 70 is fixed against rotation and movement along the torsion shaft 64. The outer end of the spring 70 is releasably connected through collars (not shown) or otherwise to the torsion shaft 64 so rotate with the torsion shaft 64.

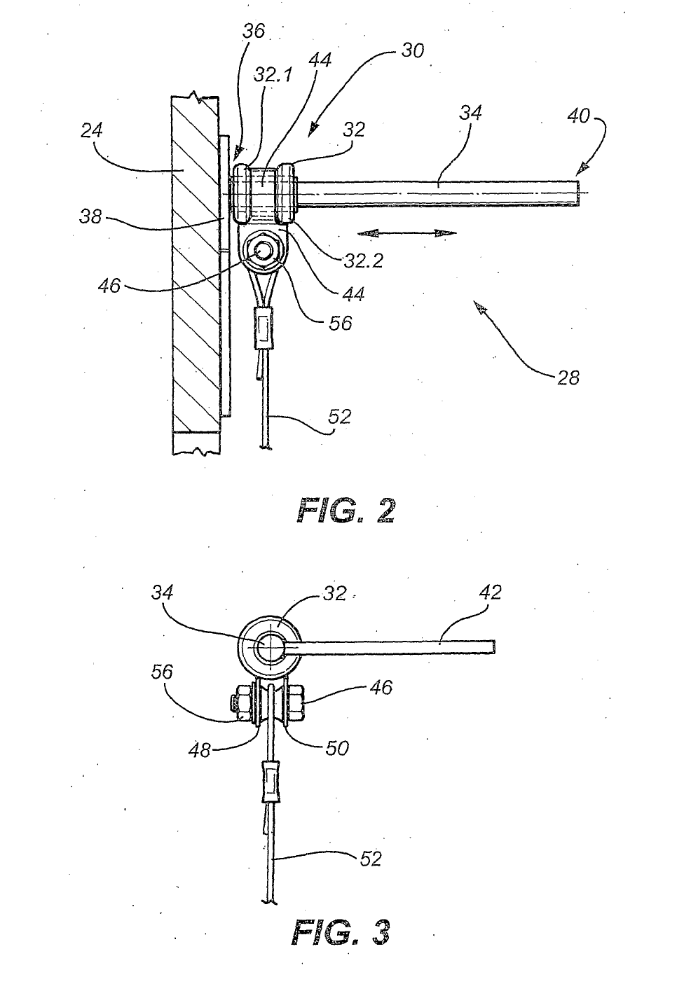

Mounted at the opposite ends of the torsion shaft 64 are cable drums 72. The lift cable 52 is wound about each cable drum 72 and extends along the front of the door at the side of the door opening and has at its upper end a loop 54 held in fixed position relative to the building structure by brackets (not shown in FIG. 1) or the like. A particularly advantageous fixing arrangement for the top of the cables will be described later with reference to FIGS. 2-4.

It will be appreciated by those skilled in the art that a tape and winding cores, or other types of filament means such as chain or cord can be used instead of the cable 52 and the cable drums 72.

The counter-balancing assembly 60 is covered by a bottom torsion cover 74 fitted to the modified muntins.

The cable drums 72 and the torsion shaft 64 rotate as a unit when the door 12 moves up or down. In particular, the cable drums 72 wind and unwind cables 52 which are connected to the drums 72 in a conventional manner known in the prior art. As the cable drums 72 are connected to the door 12 at the lower part of the door adjacent its side edges and when the door is moved downwardly, the cables wind off the drums 72 and rotate the shaft 64. When the door 12 is moved upwardly, the torsion springs 70 rotate the torsion shaft 64 and drums 72, and the cables 52 are wound onto the drums 72.

The winding of the cable drums 72 rotates the torsion shaft 64 and loads the torsion spring as will be well understood in the art.

Since the counter-balancing assembly 60 is disposed within the bottom section 14.1 of the door 12 the headroom clearance required for the installation of the sectional garage door system is substantially reduced. In particular, the headroom clearance as low as 150 mm is sufficient for most installations. Likewise, the present invention enables the increase of the walk in height of the garage opening.

FIGS. 2-4 show a fixing bracket 28 and sleeve 30 arrangement which provides a further increase in the walk in height. As best shown in FIG. 2, the sleeve 32 can slide along the a rod 34 of the bracket 28 between a first position wherein the sleeve 32 is adjacent the wall 24 and a second position wherein the sleeve 32 is adjacent the support plate 42 thereby allowing the bottom section 14.1 of the door 12 to assume a substantially horizontal position. As a result, the door 12 can be opened fully to provide an increased door opening.

At its first end 36 the rod 34 is secured to the wall 24 of the garage via a bracket 38, which may also form part of the support for the arcuate part of the track. Attached to a second end 40 of the rod 34 and extending in a direction generally perpendicular to the rod 34 is a support member 42 which attaches to the arcuate portion 22 or horizontal section of the guide track.

As shown in FIGS. 2-4, the cable loop 54 in this embodiment comprises an omega shaped sleeve clamp 44, open at its bottom, envelopes the circumference of the sleeve 32 which is securely held within the clamp 44 by tightening a bolt 46 through the lips 48, 50 at the bottom of the clamp 44. To prevent relative movement of sleeve 32 and the clamp 44 in a direction parallel to the longitudinal axis of the rod 35, the sleeve 32 is provided with end portions 32.1, 32.2 flared outwardly. It will be understood by those skilled in the art that the diameter of the clamp 44 may vary in accordance with the diameter of the middle portion of the sleeve 32.

The lift cable 52 is attached to clamp 44 by the cable loop 54 which receives the bolt 46, which, in turn, penetrates the lips 48, 50 of the clamp 44 and is secured by a nut 56.

In an unillustrated embodiment, improved smoothness of operation may be achieved by replacing the sleeve 32 with a roller mechanism, for example of the type used for pulleys. Furthermore, the inventor has found that by inclining the rod 34 slightly downwards toward the front of the opening, the cable stays forward until the lowermost panel starts to move along the curve of the door track, helping to prevent the cable from wearing against the front of the door panels.

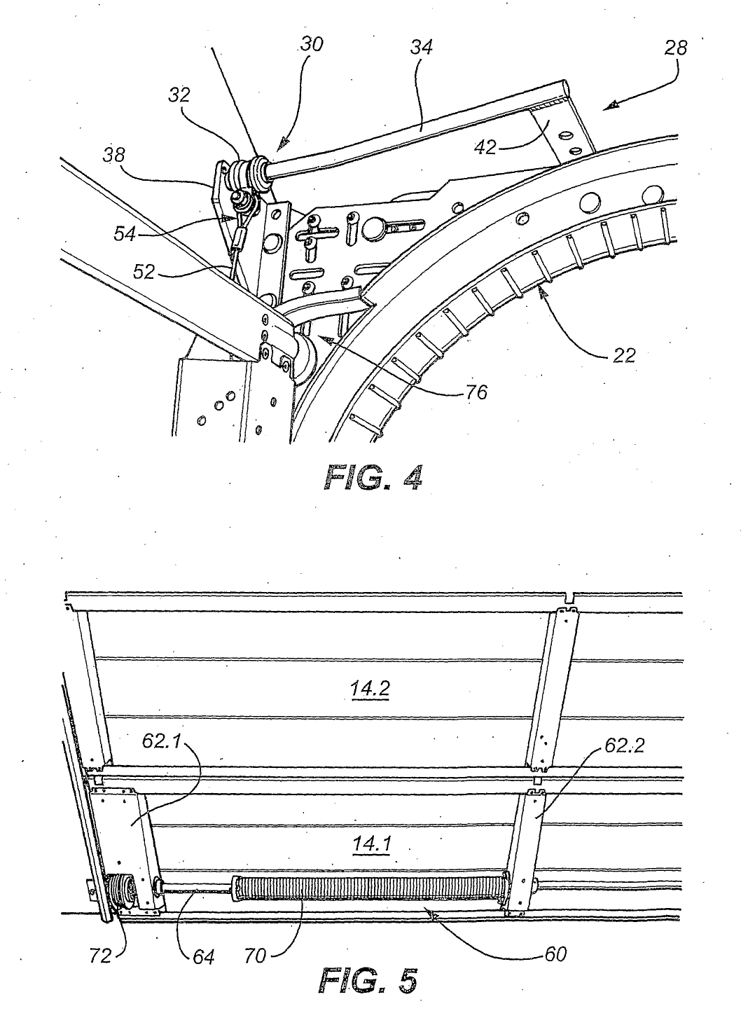

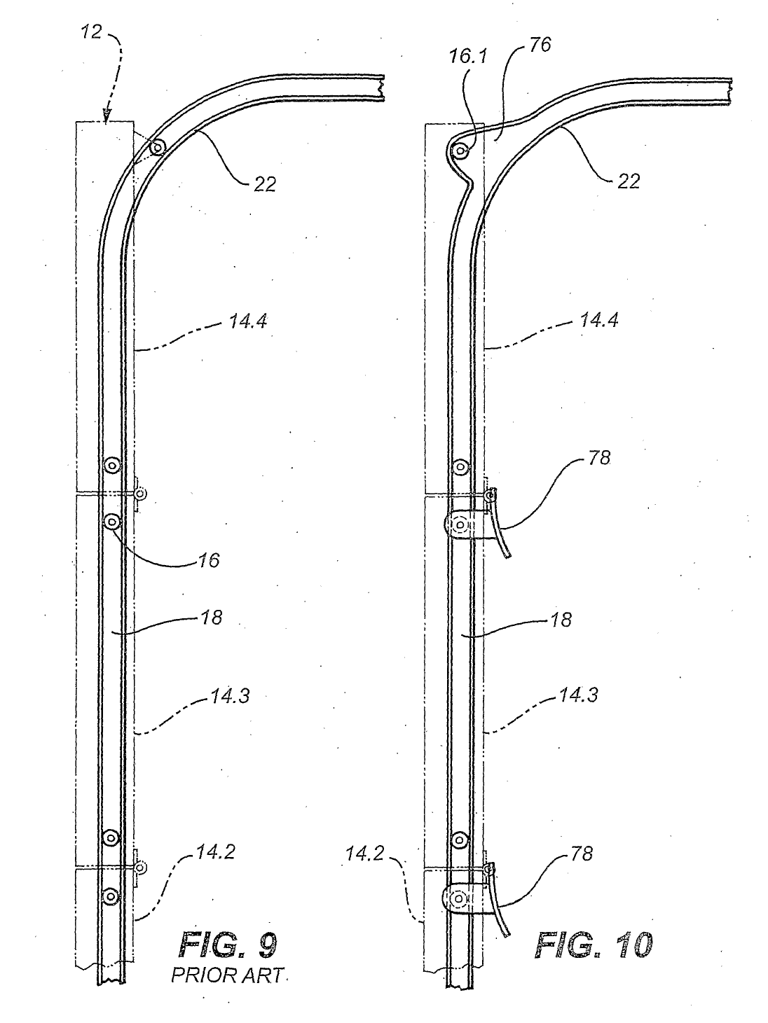

A further increase in the walk in height can be achieved by modification of the guide track and the roller arrangement of the top panel 14.4, as illustrated in FIGS. 4 and 10. In this embodiment, the top roller 16.1 in the top door pivot is mounted with its axis substantially in line with the plane of the door panel, like those of the lower panels, rather than being offset about 30 mm behind the plane as in prior art (FIG. 9). A recess 76 is provided in the door track, extending forward from the arcuate track portion 22, for receiving the top door pivot when the door is closed so that the door 12 fits flush to the door opening. As a result, a reduction of approximately 30 mm can in headroom may be achieved, as it is not necessary to raise the fixing cable bracket 28 to accommodate the offset of the top panel roller as the door is opened.

Additional guides 78 may be provided at the lower and/intermediate panel rollers to keep these rollers following the arcuate portion of the track, thus preventing those rollers from moving forward into recess 76 and jamming when the door is operated.

If desired, the modified roller fitting for the top panel and a modified recessed track section for forming the arrangement of FIGS. 4 and 10 may be supplied as kit to be installed where headroom is extremely limited.

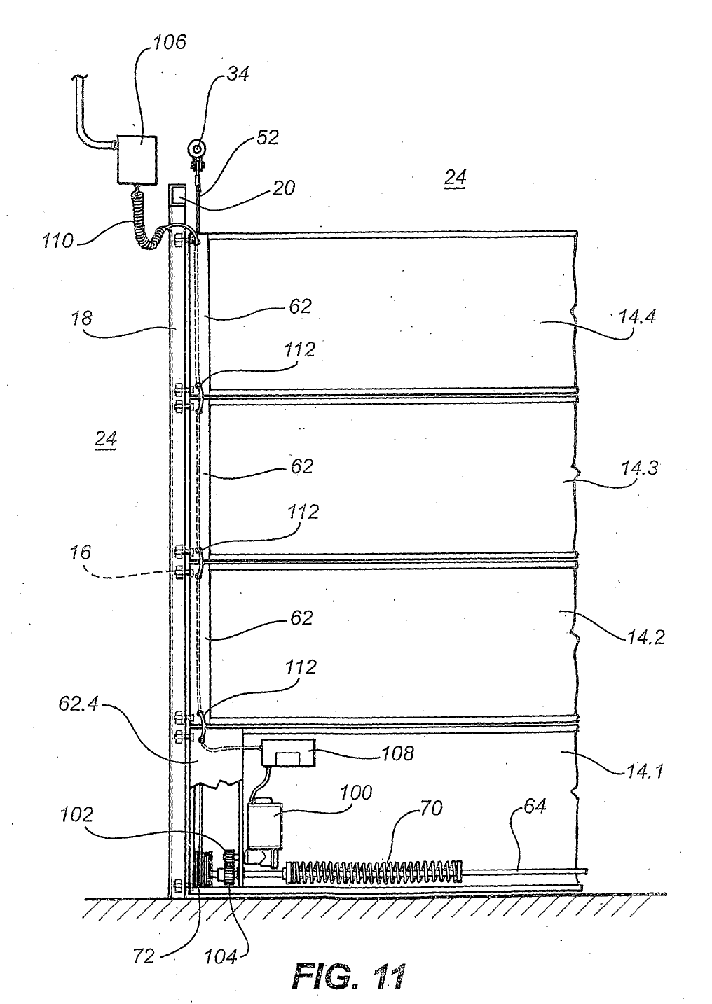

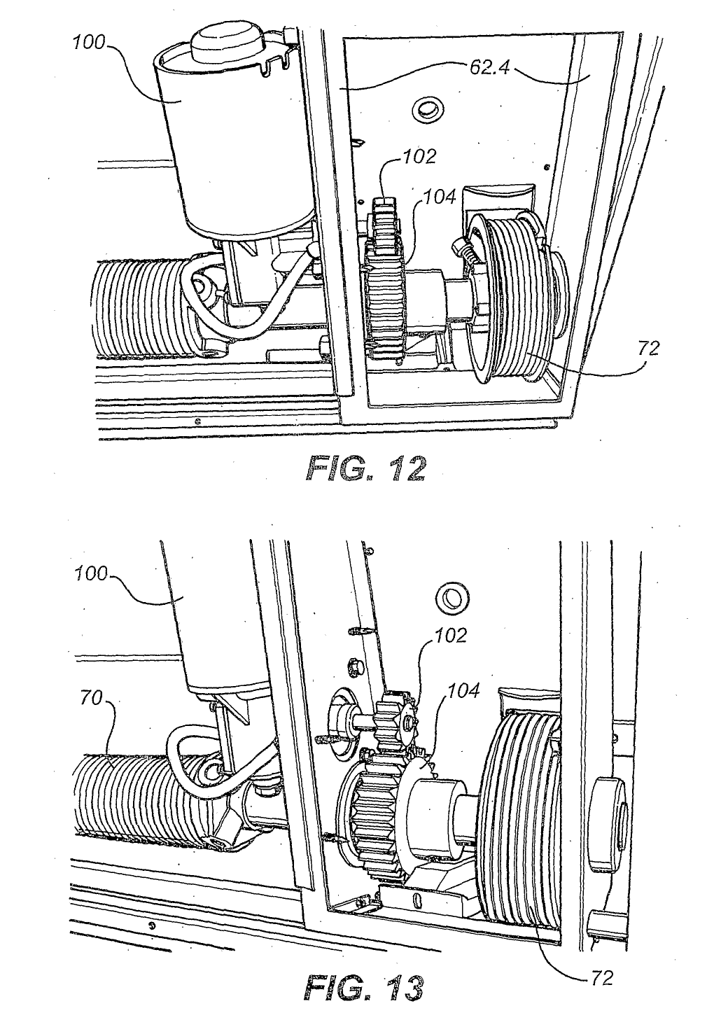

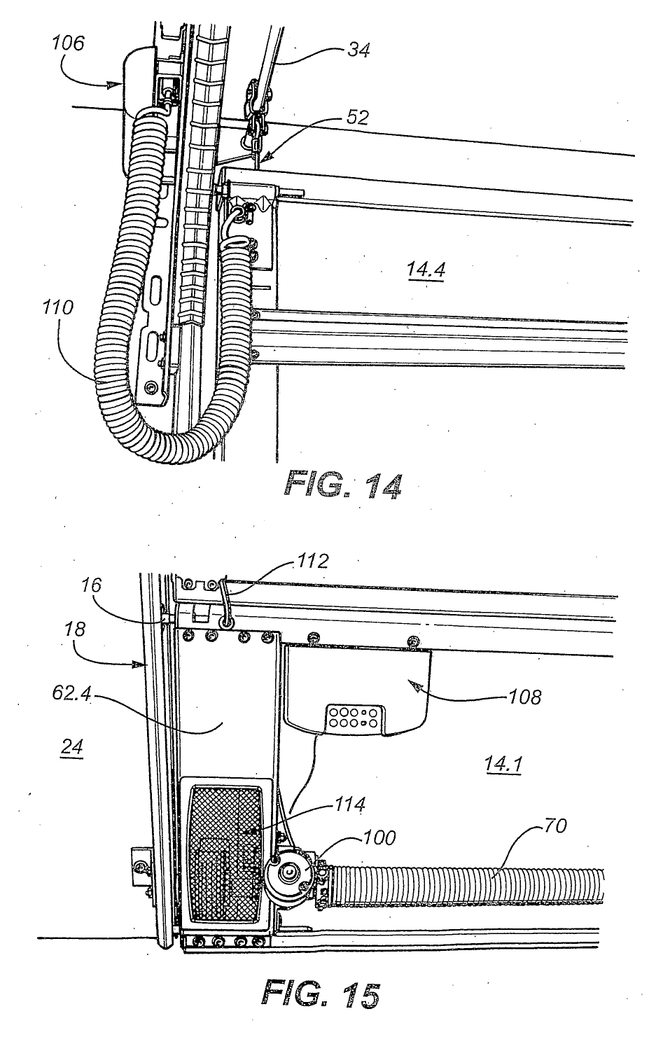

FIG. 11 schematically depicts an optional motor-driven lift mechanism for the garage door arrangement. FIGS. 12 and 13 show a drive mechanism in more detail, with the cover removed, while FIGS. 14 and 15 show a power supply and finished appearance of a modified drive mechanism.

Reference numerals in common with earlier figures indicate similar components.

With reference to FIGS. 12 and 13, the drive mechanism includes a motor 100 and drive gear 102 arrangement mounted on the lowermost panel of the door. The motor and drive gear may be of the general type employed in the prior art, for example a worm gear arrangement as commonly employed in the prior art, driving rotation of the drive gear 102 and in turn driving rotation of the cable drum and torsion spring shaft via gear 104.

The cable drum 72 and torsion spring 70 operate as previously described.

FIG. 14 shows the mounting of a power transformer 106 near the top of the door, having a mains voltage input and low voltage output. The low voltage output is provided to the motor 100 and door controller 108 (FIG. 15) via a power cable which includes an upper retractable ‘curly cord’ portion 110 leading between the transformer output and the top door panel side muntin, and a straight cord portion 112 which feeds down through the side muntins 62 of the panels 14.1 to 14.4 to the door controller 108 and the motor 100 on the lowermost panel 14.1.

The front surface each door panel, at the edges behind the respective side of the door opening, may have adhered thereto an angle section of plastics, metal or other suitably weather resistant material to help protect the power cable 112 and the lift cable 52 from the weather.

The purpose of the curly portion 110 of the power cable is to allow lengthwise expansion of the cord as the top of the door moves away from the transformer as the door is raised, and retraction as the door is lowered.

With reference to FIG. 15, the door controller 108 is of the conventional type, containing user control buttons for operation of the door and further adapted to detect instructions from a remote control unit (not shown), and containing a light which operates for a set period after raising or lowering of the door.

The motor shown in FIG. 15 is of a different type to that of FIGS. 12 and 13 and is mounted at a different angle, but is generally similar in principle and operation.

As apparent from FIGS. 12, 13 and 15, the drive gear arrangement is contained within the cavity of a broadened side muntin 62.4, which may have a removable access panel 114 to allow maintenance. It will be appreciated that, in FIGS. 12, 13 and 15 the bottom torsion cover 74 covering the torsion shaft and spring is removed, but will be present the finished arrangement.

By providing a door lift mechanism on the door itself rather than suspended overhead from the garage ceiling to lift the door via a chain drive as is done in the prior art, ease of installation and the aesthetics of the arrangement are improved. Furthermore, access to the door controller, motor and drive gear arrangement for maintenance and adjustment is greatly improved.

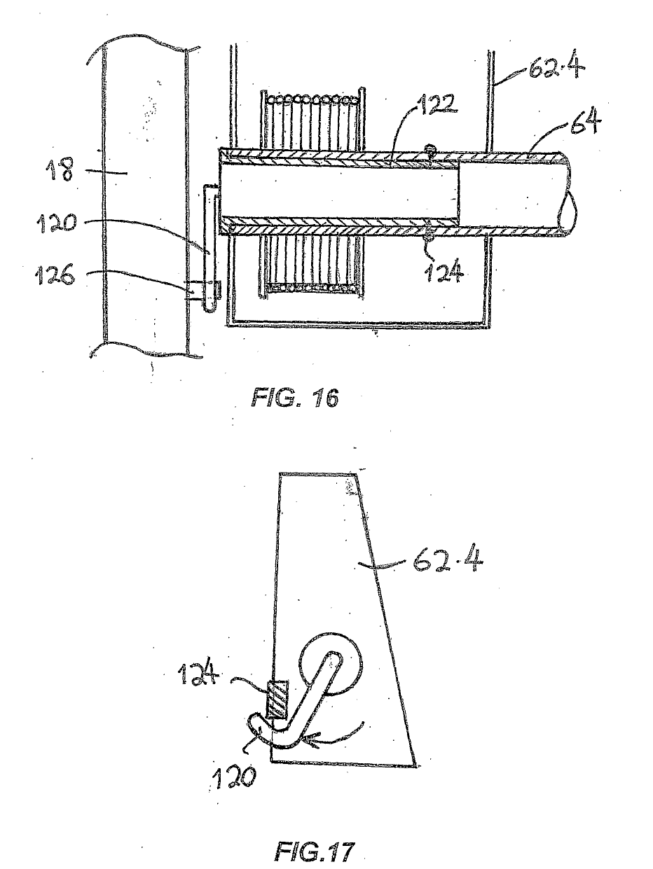

FIGS. 16 and 17 are respectively a part sectional view and side elevation showing a door curtain latch arrangement according to one embodiment, especially for use with those doors with the drive unit mounted to the door curtain.

The latch arrangement includes an L-shaped or hook-shaped latch member 120 Connected to a sleeve 122 mounted within the torsion spring shaft 64, for example via screws or other fasteners 124 passing through the shaft 64 into the sleeve.

The latch member 120 co-operates with a tab 126 or other formation on the guide track 18 to restrain the door curtain from being lifted.

As the door is lowered the torsion shaft 64 rotates, and with it the sleeve 122 and latch 120. As the door curtain reaches the bottom of its travel, the rotation of the latch takes it to a position under the tab 126 on the guide track 18 as shown by arrow 128. Any attempt to force the door open will lift the door curtain without rotation of the shaft 64, and the extent of lifting will be limited by the latch striking the tab. However, when the door is opened using the drive unit or manually with the clutch disengaged, the shaft 64 and latch 120 will rotate in the opposite direction to clear the tab and will thus permit the opening of the door.

Alternative types of latching mechanisms may be employed, for example one or more solenoid-driven latch bolts (not shown) co-operating with the guide track.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. An overhead sectional door apparatus operative to open and close a door opening, including:
a door curtain having a plurality of connected panels;
guide track means for guiding movement of the door curtain between a closed, lowered position and an open, overhead position; and
a counterbalancing mechanism for applying a counterbalancing force acting against the weight of the door curtain, including:
a spring mechanism mounted to the door curtain so as to be raised or lowered with operation of the door; and
a loading mechanism for loading the spring as the curtain is lowered, so as to create a counterbalancing force acting against the weight of the door curtain.

2. A door apparatus according to claim 1, wherein the spring mechanism is mounted on a lowermost panel of said door curtain.

3. A door apparatus according to claim 1, wherein said spring mechanism is a torsion spring mechanism and wherein said loading mechanism is a winding mechanism acting to wind up said torsion spring mechanism as the door curtain is lowered.

4. A door apparatus according to claim 3, wherein said winding mechanism includes a fixing point attached to the building structure, and filament means fixed at one end thereof to the fixing point.

5. A door apparatus according to claim 4, wherein said filament means is operatively attached at the other end thereof to a torsion member of said spring mechanism.

6. A door apparatus according to claim 4, wherein said filament means is a cord, cable, chain, tape or the like.

7. A counterbalancing mechanism for an overhead sectional door, said door having a door curtain having a plurality of connected panels, said counterbalancing mechanism including:
a spring mechanism,
means for mounting the spring mechanism to the door curtain so as to be raised or lowered with operation of the door; and
a loading mechanism for loading the spring as the curtain is lowered, so as to create a counterbalancing force acting against the weight of the door curtain.

8. A counterbalancing mechanism according to claim 7, wherein the spring mechanism includes a torsion spring arrangement on a torsion shaft mounted on the door curtain, and wherein the loading mechanism acts between the spring mechanism and a fixing point attached to the building structure.

9. A counterbalancing mechanism according to claim 8, wherein the fixing point is a fixing member for one end of a filament means extending between the fixing point and the spring mechanism.

10. A counterbalancing mechanism according to claim 9, wherein the attachment of the filament to the fixing member allows forward/rearward movement of the fixing point.

11. A door curtain of an overhead sectional door apparatus, said a door curtain having a plurality of connected panels, at least one of said panels having means for mounting thereon a torsion spring mechanism of a counterbalancing mechanism.

12. A door curtain according to claim 11, wherein said mounting means is on a lowermost panel of said door curtain.

13. A door curtain according to claim 11, further including a cover for said torsion spring mechanism.

14. A door curtain according to claim 11, wherein said mounting means includes one or more modified side reinforcing members of the panel.

15. A method of fitting a counterbalancing mechanism to an overhead sectional door, said door having a door curtain having a plurality of connected panels, including the steps of:
fitting one or more modified side reinforcing members to a said panel;
mounting a spring mechanism to said panel via said modified side reinforcing members so as to be raised or lowered with operation of the door;
fitting a loading mechanism for the spring mechanism, including the step of securing a fixing member for a part of the loading mechanism to a stationary building structure.

16. An overhead sectional door apparatus operative to open and close a door opening, including:
a door curtain having a plurality of connected panels; and
a guide track for guiding movement of the door curtain between a closed, lowered position and an open, overhead position; the guide track including a lower generally vertical track section and an upper generally horizontal track section joined by an arcuate section;
the guide track having a recess extending forward from adjacent the arcuate track section for receiving a guide wheel of an uppermost one of said panels.

17. A door apparatus according to claim 16, further including one or more guides at a lower panel for preventing a guide wheel of said lower panel moving forward into said recess.

18. A door apparatus according to claim 1, further including a motorised lifting mechanism including a drive unit mounted on the door curtain.

19. A door apparatus according to claim 18, wherein the drive unit is mounted on a lowermost panel of said door curtain.

20. A door apparatus according to claim 19, wherein said drive unit is mounted within one or more modified side reinforcing members of the panel.

21. A door apparatus according to claim 19, wherein said drive unit includes a motor and a gearbox.

22. A door apparatus according to claim 19, further including a control unit mounted on said lowermost panel of said door curtain.

23. A door apparatus according to claim 19 or 22, further including a power supply including a transformer attached to the building structure and a power cable carrying a transformed voltage to said motor and/or control unit.

24. A door apparatus according to claim 18, further including a latch member mounted to be raised or lowered with the door curtain and operative to restrain movement of the door curtain relative to the door opening.

25. A door apparatus according to claim 24, wherein said latch member engages with a formation attached to the guide track.

26. A door apparatus according to claim 25, wherein said spring mechanism is a torsion spring and wherein latch member is mounted to rotate with a shaft of said torsion spring to engage said formation as the door curtain is lowered to a closed position.
